(19) United States
(12) Patent Application Publication
(10) Pub. No.: US 2005/0214712 A1
(43) Pub. Date: Sep. 29, 2005

(54) Dental stain remover

(76) Inventor: Farzad Shaygan, Tustin, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/062,172

(22) Filed: Feb. 18, 2005

Related U.S. Application Data
(60) Provisional application No. 60/546,499, filed on Feb. 20, 2004.

(51) Int. Cl. A61C 3/06

(52) U.S. Cl. 433/125

(57) ABSTRACT

In one embodiment, a dental stain removing device is disclosed. The dental stain removing device preferably comprises a polishing cup, a handle having a longitudinal axis generally perpendicular to a longitudinal axis of the polishing cup, and a neck. The neck is connected to the handle at a proximal end and is connected to the cup at its distal end. A motor and power source are located within the handle, and a shock-absorbing adapter for coupling the neck to the handle is also disposed within the device.

### RELATED APPLICATIONS

This application claims priority under 35 U.S.C. §119(e) to U.S. Provisional Application No. 60/546,499, filed on Feb. 20, 2004, the entire contents of which are herein incorporated by reference in their entirety.

### BACKGROUND OF THE INVENTION

1. Field of the Invention

Preferred embodiments of the invention generally relate to portable dental devices and, in particular, relate to a portable, hand-held, battery-powered dental apparatus for safely removing stains and/or plaque from teeth.

2. Description of the Related Art

Dental devices for removing stains from teeth are well-known in the art. Typically, such dental devices are used by trained dentists or dental hygienists in order to clean a patient's teeth while at the dentist's office. Such dental devices often comprise a rather bulky air motor attached to an adapter, which is in turn attached to a disposable or reusable neck piece used to apply a dental stain removing paste or cream. Such a device is clearly inconvenient for home use, and may even be dangerous for the home user.

Indeed, home users of dental stain removers may not be aware of the risk posed to their teeth by the abrasive pastes and creams used in combination with the paste-containing polishing cups that rotate at high velocities on the necks of the dental devices. It is desirable therefore to provide home users with a more convenient, safe device, with which a person can remove stains from their teeth in the comfort of their own home.

Of course, there are many difficulties with adapting the equipment found in the dentist's office to home use. For example, the output of a small motor, such as would typically be used in a small household appliance, is at relatively high rpm compared to the desired oscillation frequency of the device's polishing cup. It would therefore be desirable to reduce the motor's output speed to drive the cup at a lower speed. Furthermore, it would desirable to use conventional neck pieces, such as are commonly found in dental offices, in home dental devices, providing the same cleaning power in a portable device.

### SUMMARY OF THE INVENTION

Preferred embodiments of the invention generally relate to portable dental devices and, in particular, relate to a portable, self-contained, hand-held, battery-powered dental apparatus for safely removing stains at home. In some embodiments, a dental device is provided that can be manipulated and activated by grasping it with one hand. The device is preferably contoured for easy manipulation by an individual, allowing easy access to the user's teeth. Embodiments of the invention also preferably reduce the risks to a user's teeth by providing a gear-reduction mechanism to reduce the rotational speed of the polishing cup. In further preferred embodiments, light-emitting structures may also be used to illuminate the teeth and inside of the mouth during cleaning.

In one embodiment, a light-emitting dental stain removing apparatus for removing stains from teeth comprises a handle, head, polishing cup, and a neck extending from the handle to the head. A drive shaft also extends through the neck to the head. A motor may be situated within the handle and may comprise a pair of spaced recesses and an output shaft situated between the recesses. A reduction gearbox can then receive torque from the output shaft of the motor and transmit it to the drive shaft at a reduced speed. One such gearbox has a base plate having a pair of projections extending into the recesses of the motor, a cover plate fixed to the base plate and at least one gear set between the base plate and the cover plate to transmit torque from the motor to the drive shaft.

In preferred embodiments, the polishing cup and/or neck of the device may be replaceable. Light may also be projected into the user's mouth directly from a light bulb, LED, or through fiber optics embedded within the apparatus. The invention is further directed towards dental stain removing devices that can be carried by the individual and used at home or work by the individual for periodic removal of stains from his or her teeth.

In a further preferred embodiment, a dental stain removing device is disclosed. The dental stain removing device preferably comprises a polishing cup, a handle having a longitudinal axis generally perpendicular to a longitudinal axis of the polishing cup, and a neck. The neck is connected to the handle at a proximal end and is connected to the cup at its distal end. A motor and power source are located within the handle, and a shock-absorbing adapter for coupling the neck to the handle is also disposed within the device.

### BRIEF DESCRIPTION OF THE DRAWINGS

FIG. 1 is a cross-sectional schematic view of a stain remover.

FIG. 2 is a side view of internal parts of the stain remover of FIG. 1.

FIG. 3 shows the other side of the internal parts of the stain remover of FIG. 2.

FIG. 4 is a schematic exploded view of the drive train components of the stain remover of FIG. 1.

FIGS. 5A to 5G are schematic illustrations of component parts of the drive train.

FIG. 6 shows a simplified view of a motorized stain remover with a light bulb.

FIG. 7 shows an exploded view of the stain remover of FIG. 6.

FIG. 8 shows an exploded view of a stain remover with a fiber optic light mechanism.

FIG. 9 shows a side view of a stain remover with an oscillating drive train and light.

FIG. 10 shows a cross-sectional schematic side view of a stain remover with an oscillating drive shaft and connector.

FIG. 11 shows a cross-sectional schematic side view of a dental stain remover, configured in accordance with one embodiment of the present invention.

FIG. 12A shows a cross-sectional side view of an alternative stain-removing polishing cup for use in one embodiment in the present invention.

FIG. 12B shows a top view of the alternative stain-removing polishing cup of 12A.

FIG. 13 shows a substantially central longitudinal sectional view through a prophy angle of the present invention.

FIG. 14 shows an exploded perspective view of the prophy angle of FIG. 13.

FIG. 15 shows a cross-sectional view taken at line 15-15 of FIG. 13.

### DETAILED DESCRIPTION OF THE PREFERRED EMBODIMENT

In operation, the dental instruments disclosed herein may be used to remove stains from the outer surfaces of a user's teeth, which may have developed over a period of time from smoking, drinking coffee, tea or other dentifrice-coating activities. The instruments may also be specifically designed for consumer use, so that any operator can use them without professional training, and with the use of only one hand.

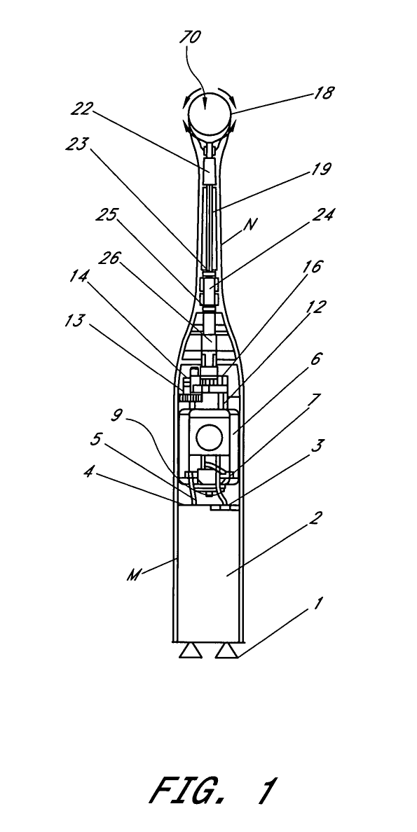

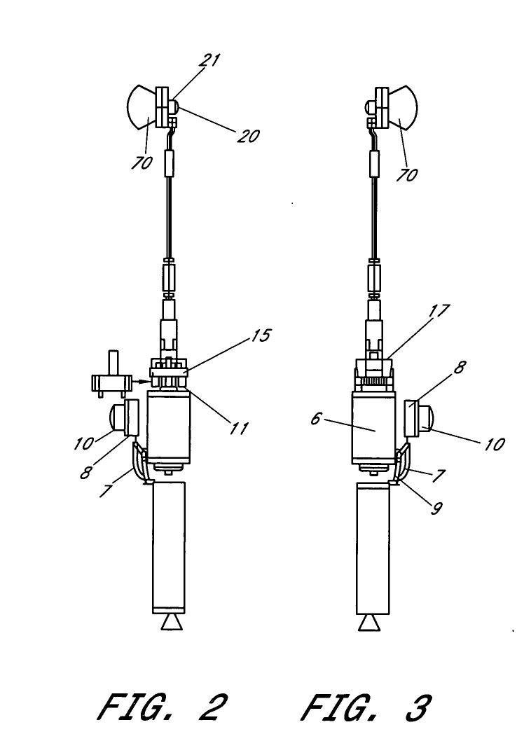

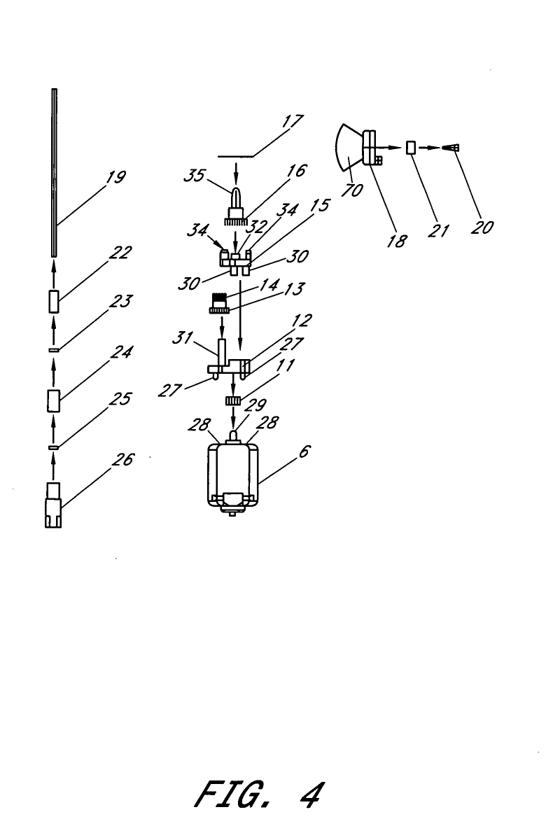

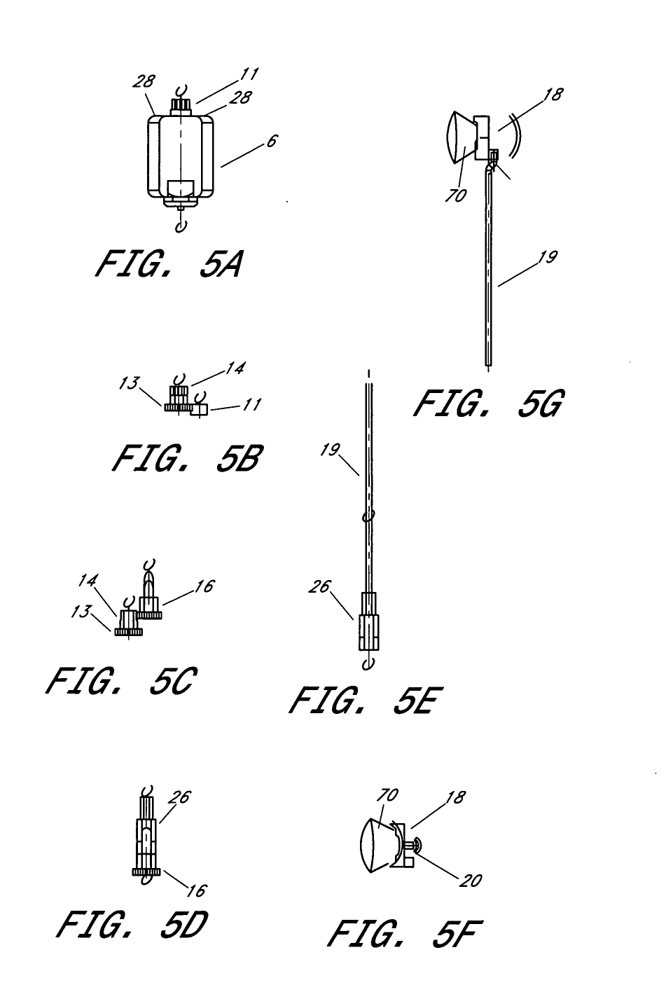

In FIGS. 1 to 5G, a preferred embodiment of an electric stain removing apparatus is shown. The apparatus comprises a plastic housing having a handle H and a neck N formed integrally with the handle. A power source may be located within the handle H, such as a battery, a pair of batteries 2 (as shown), or more than two batteries. These batteries may be of the disposable or rechargeable type. In the illustrated embodiment, two batteries are connected in series at the base by a coil spring and conductive plate arrangement 1.

At the distal end of the batteries, one is connected to a positive terminal 3, whereas the other is connected to a negative terminal 4. The positive terminal 3 is preferably connected via a switch wire 7 to a switch 8 that has an ON/OFF button 10. In preferred embodiments, the ON/OFF may remain in the on or off position once pressed and switch to the other position when pressed again.

Of course, as would be well understood by those skilled in the art, the power source may comprise any of a number of available power sources that might be found in a typical household. For example, the power source may be an electrical outlet, coupled to the handle H by a power cord. The power from the electrical outlet may be converted within the handle to a direct current that may be more easily used by the device. In another embodiment, the power source may comprise, for example, a capacitor that may be charged when the device is coupled to an electrical outlet. Of course, the switch used to activate the electrical stain removing apparatus may also be any of a number of switches well known to those skilled in the art. For example, the switch may be slidable, or may provide a number of different options by which a user can select different speeds at which the polishing cup will spin.

The switch 8 is preferably connected to an electric motor 6 via a switch-motor wire 9. The positive terminal 4 may be connected directly to the motor 6 via a battery-motor wire 5. Thus, the motor may receive power when the switch is in the “on” position. The motor 6 has in its upper surface a pair of recesses 28, between which an output shaft 29 extends. A gearbox base plate 12 may also be mounted directly to the motor 6. Base plate 12 is typically formed of molded plastic material and may have a pair of projections 27 that extend downwardly. These projections 27 may be configured to slide into the respective recesses 28. In a preferred embodiment, the output shaft is coupled to a plurality of gears that reduce the speed of the shaft. Fixed to the output shaft 29 in one embodiment is a first driving gear 11. The base plate 12 preferably has an outstanding pin 31, onto which a first driven gear 13 is rotatably mounted. The first driven gear 13 then meshes with the first driving gear 11, and a second driving gear 14 is formed integrally with the first driven gear 13.

In a preferred embodiment, a gearbox cover plate 15 is fixed to the base plate 12 by a pair of bridges 30. Thus the first driving gear 11 and the first driven gear 13 are sandwiched between the base plate 12 and the cover plate 15. This maintains the meshing inter-engagement between the gears 11 and 13.

The cover plate 15 also preferably includes a pin 32, upon which there is rotatably mounted a second driven gear 16. This gear is maintained in position upon the pin 32 by a retaining plate 17, typically formed of stainless steel. The plates 12 and 15 are typically formed of molded plastic materials, such as nylon, for example. The gears 11, 13, 14 and 16, in contrast, are typically formed of metal or hard-wearing plastic materials.

A pair of fixing lugs 34 may be used to secure the retaining plate 17 to the cover plate 15. The fixing lugs 34 are typically formed integrally with the cover plate 15. They may include narrowed top portions that pass through corresponding apertures in the retaining plate and are often coupled to the retaining plate 17 by a plastic-molding or welding process.

The retaining plate 17 thereby maintains inter-engagement between the second driving gear 14 and the second driven gear 16.

Of course, as would be well understood by those skilled in the art, the motor 6 may be selected from a variety of small motors used in common household devices. For example, in one embodiment, a Mabuchi RE-140-18100 motor may be used. Similarly, as would be well understood by those skilled in the art, the motor may be coupled to the polishing cup by any of a variety of gear mechanisms. Typically, these gears are used to reduce the speed at which the output shaft from the motor 6 runs, as well as change the axis of rotation of the output energy. For example, in a preferred embodiment, the axis of rotation about which the output shaft rotates is perpendicular to the axis of rotation of the polishing cup, allowing the user to more easily move the polishing cup and device within the user's mouth.

In a preferred embodiment, an output member 35 may be formed integrally with the second driven gear 16. Output member 35 might be in the form of an externally tapered or straight spleen, or a short shaft with a key-way. The output member 35 is received within a coupling 26 that is affixed to an input end of drive shaft 19, extending through the neck N of the dental apparatus. The drive shaft 19 may be mounted in bushings 22 and 24. These bushings help to maintain the drive shaft 19 within the neck N. A pair of O-ring seals 23 and 25 may also be positioned around the drive shaft 19, thereby preventing the ingress of liquid downwardly along the shaft toward the gearbox and motor.

As illustrated, the driveshaft 19 has a dogleg portion 33 that may be received within a slot of the polishing cup head 18. The polishing cup head 18 is mounted upon a positioning shaft 20 having a positioning sleeve 21. The positioning shaft 20 may define an axis of rotation of the polishing cup head, as illustrated by the arrows in FIG. 1.

In one embodiment, a plastic or rubber polishing cup 70 is attached to the polishing cup head 18. The polishing cup 70 preferably comprises a flexible plastic that is configured as a semi-spherical shape adapted to hold stain removing paste or cream as is well-known to those skilled in the art. In alternative embodiments, the polishing cup 70 may be preferably replaced with a camel hair brush, a conventional circular bristle brush, or other stain and/or plaque-removing structures known to those skilled in the art.

In use, the ON/OFF button 10 may be depressed to provide electric current to the motor 6, which turns the first driving gear 11. The rotational speed of the motor's output shaft 19 is reduced through the gearbox, such that the output member 32 turns at a lower speed. This results in reduced speed and increased torque delivered to the drive shaft 19.

In a further preferred embodiment, a light-emitting device may also be provided to illuminate the mouth and teeth. Illuminating toothbrushes are disclosed in U.S. Pat. No. 5,160,194, issued to Feldman; U.S. Pat. No. 6,202,242, issued to Salmon et al.; and U.S. Pat. No. 5,813,855, issued to Crisio; the contents of which are hereby incorporated by reference in their entirety. In preferred embodiments of the present invention, the stain removing device comprises a battery-powered light bulb, which is angled to project light into the user's mouth. In some preferred embodiments, the bulb may be located at the distal end of the handle closest to the neck. Alternative embodiments may include a bulb located on the neck of the stain removing device.

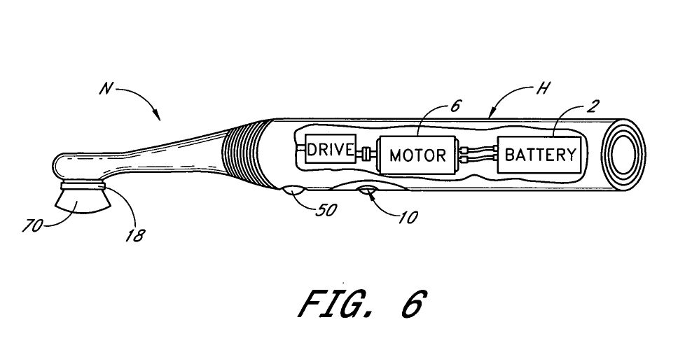

In a preferred embodiment of the illuminated stain remover device illustrated in FIG. 6, the bulb 50 is a high-output, krypton gas filled, incandescent bulb having a tip that projects slightly from the center of handle H.

When in use, the bulb 50 shines a bright divergent beam of white light, angled slightly downwards, from handle H generally onto the polishing cup 70 and into the user's mouth. Users may find that the illumination greatly improves their ability to see teeth and plaque. In one application, the plaque may first be stained by a disclosing or coloring solution. As a result, the user's stain-removing efficiency can be greatly improved.

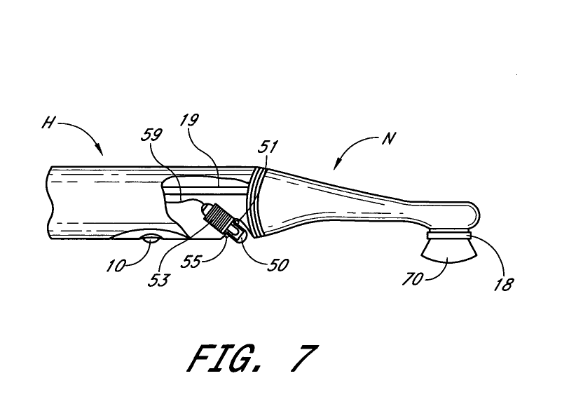

In the device illustrated in FIG. 7, the plastic or glass bulb 50, which preferably requires three volts to operate, has a metal electrical terminal or threaded case 53, and a rearward projection that receives power from the battery 2 via a light bulb power supply chord 59. The plastic or glass portion of the bulb 50 is generally cylindrical in shape but widens at the base to form a transition 55, around which is disposed a small rubber O-ring 51. The bulb 50 may be frictionally fitted within a corresponding cavity in handle H, or neck N to expose only the tip of the bulb 50. Preferably, the small O-ring 51 is compressed between the transition 55 and a corresponding portion of the cavity to provide a watertight seal. The bulb 50 may be positioned at a slight downward angle to project its light beam likewise. A lamp with a lower power consumption but extremely high output, such as Radio Shack Model 276-086 LED and a suitable series resistor, may be substituted for light bulb 50 to produce more efficient illumination. In another embodiment, a xenon lamp, such as Ray-O-Vac T-1, may be used.

In another preferred embodiment, the stain removing device may comprise fiber optics that deliver light from an internal light source at an angle adequate to project the light into the user's mouth. In some preferred embodiments, the light-emitting end of the fiber optics may be located at the distal end of the handle closest to the neck. In other embodiments, the light-emitting end of the fibers may be located on the neck of the stain removing device. Fiber-optic containing tooth brushes are disclosed in U.S. Pat. No. 5,030,090, issued to Maeda et al.; and U.S. Pat. No. 4,779,173, issued to Carr et al., both of which are hereby incorporated by reference in their entirety.

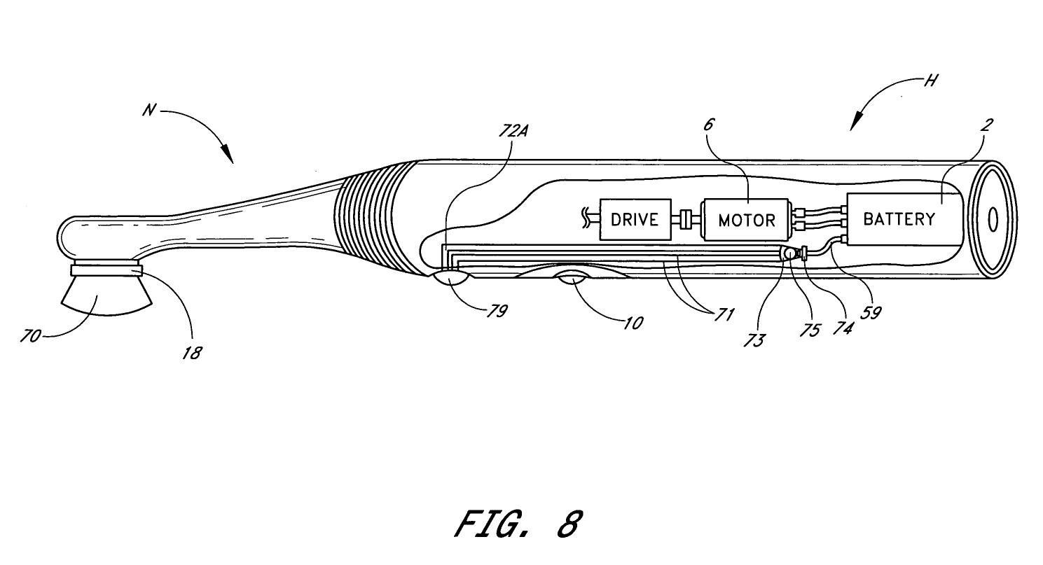

In one preferred embodiment of a stain removing apparatus, illustrated in FIG. 8, a fiber-optics bundle 72 may be used to guide light generated by an internal light bulb 75. A plurality of narrow, photo-transparent fibers 71 are bundled together to form a narrow fiber bundle 72. Each transparent fiber 71 has a thin metal layer as an outer covering, which can reflect internal light traveling through the fiber to prevent loss of the light, as is well-known to those skilled in the art. The base part of the narrow fiber bundle 72 may be connected to the base portion of a cone-shaped connector 73, preferably composed of quartz glass.

An internal light bulb 75 serves as a light generating device and is mounted on stem 74. The internal light bulb's 75 illuminating end is connected to the vertex of the cone-shaped connector 73, and an electrode terminal of the internal light bulb 75 projects from the stem 74 and is connected to a battery 2 through a light bulb power supply cord 59. At the end of the narrow fiber bundle 72, the bundle includes a bent portion 72a that directs light through a water-tight plastic or glass covering 79 into the user's mouth. Preferred embodiments of the fiber-optic stain remover may preferably comprise a separate power source for the light.

When used to clean a user's teeth, power is supplied through the light bulb power supply cord 59 to the internal light bulb 75, so that light is emitted from the internal light bulb 75. This light is guided through the cone-shaped connector 73 and enters the narrow fibers 71. As the light travels through each fiber 71, it is continually reflected inside the fiber 71 due to the surrounding metal layer. Light is thus conveyed by the fiber bundle 72 through the plastic or glass covering 79 into the user's mouth.

The light beam is preferably guided to the narrow fiber bundle 72 without loss because the cone-shaped connector 73 is firmly placed between the internal light bulb 75 and the bundle 72.

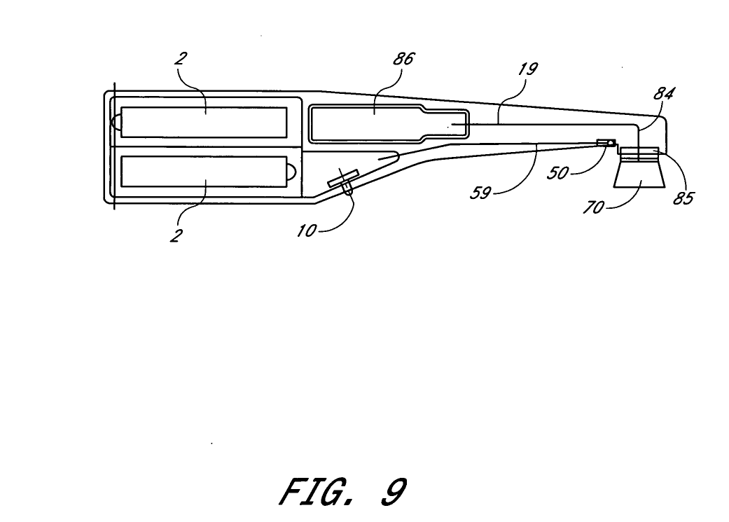

In another preferred embodiment, shown in FIG. 9, a light-emitting dental stain remover with an oscillating polishing cup is shown. The motor 86 of this stain remover causes the polishing cup 70 to oscillate, rather than rotate. In preferred embodiments, the motor 86 drives the oscillating drive shaft 19.

The drive shaft 19 preferably has a bend 84, such that the distal end of the shaft 19 oscillates as the shaft is rotated. In a preferred embodiment, the bend 84 comprises a ninety degree angle. In other embodiments, the bend 84 preferably comprises at least a sixty degree angle. Further embodiments preferably comprise at least a ninety-five degree angle. The drive shaft 19 preferably oscillates in a manner that results in side-to-side oscillation of the polishing cup 70.

The embodiment shown in FIG. 9 further comprises an O-ring 85, which preferably reduces the noise produced by the device and further prevents fluids from entering the device. The O-ring 85 preferably comprises rubber or plastic, as would be well known to those skilled in the art.

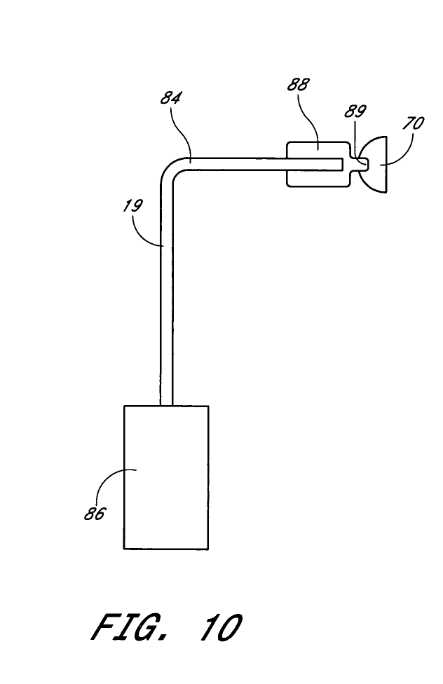

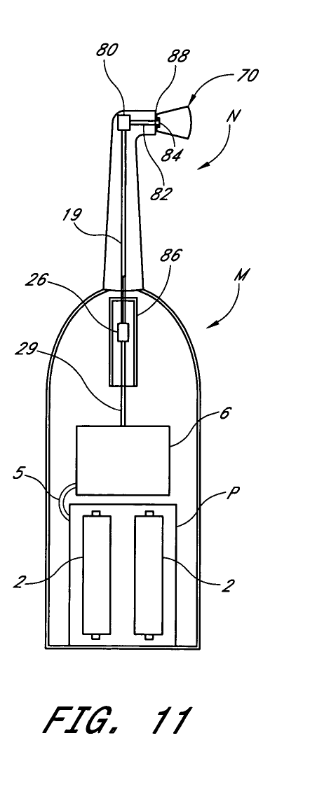

In the view shown in FIG. 10, it may be more easily seen that drive shaft 19 is attached to a connector 88. The connector 88 also preferably acts as a seal to prevent fluids from entering the device. The connector 88 may additionally act as a noise reducer. The connector 88 may preferably comprise rubber or plastic, as is well known to those skilled in the art. The polishing cup 70 may then be connected to a protruding portion 89 of the connector 88.

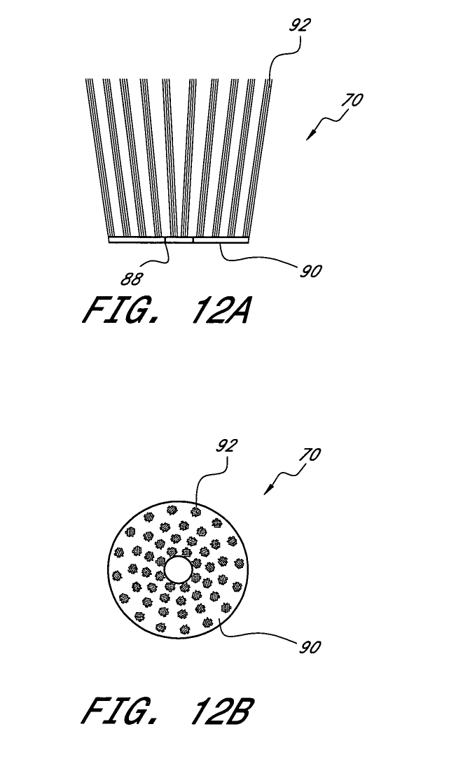

In FIG. 11, another embodiment of a dental stain-removing apparatus is illustrated. Like the embodiments described in detail above, the apparatus generally comprises a handle H and a neck N attached to a polishing cup 70. In one preferred embodiment, the handle H has disposed therein a motor 6 coupled to an output shaft 29. The motor 6 is preferably driven by a power source P, which, in a preferred embodiment, comprises batteries 2. As is well-known to those skilled in the art, and as discussed above, the power source P may be connected to the motor by a battery-motor wire 5. When the power source P provides power to the motor 6, the motor 6 may spin the output shaft 29 about an axis of rotation extending generally parallel to the longitudinal axis of the neck N.

As would be well understood by those of skill in the art, the motor 6 and power source P may comprise any of a number of relatively small power sources or motors as would be used in other conventional small household appliances. For example, in one embodiment, the battery and motor may be configured similarly to a battery and motor system found in a conventional egg beater.

The neck N may comprise any of a number of structures that are configured to alter the rotational axis of a rotating shaft by approximately 90°. The neck N may alter the rotational axis between 120° and 60°, which is a comfortable range for a user to easily access his or her teeth. In a preferred embodiment, the neck N may comprise a commercially available product produced by Dentsply, sold under the trade name Midwest RDH For Disposable Angles, Model No. 740000. A more complete description of one such product may be found in U.S. Pat. No. 5,040,978, issued to Falcon et al., which is hereby incorporated by reference in its entirety.

As illustrated, the neck N comprises a drive shaft 19, a gearbox 80, a second drive shaft 82, and a cup adapter 84. The cup adapter 84 preferably has disposed thereon the polishing cup 70. As is well-known to those of skill in the art, a neck N, such as is configured herein, is typically attached to an air motor in a dentist's office.

In order to adapt the neck N to be driven by the handle H, a special coupling 26 and adapter 86 are used to couple the two structures. In a preferred embodiment, the coupling 26 couples the drive shaft 19 to the output shaft 29, allowing the motor 6 to spin the drive shaft 19 in the neck N. In a preferred embodiment, the adapter 86 is configured to completely surround a portion of the drive shaft 19, the coupling 26 and a portion of the output shaft 29. The adapter 86 preferably comprises a generally cylindrical rubber member. This adapter 86 preferably reduces noise and reduces the vibrations caused at the interface between the drive shaft 19 and the output shaft 29. Of course, the adapter may comprise any of a number of relatively shock-absorbing materials, such as plastics, rubbers, or other polymeric materials.

The polishing cup 70 may be formed in a number of ways well known to those of skill in the art. In the illustrated embodiment, the polishing cup 70 is generally cylindrical, and defines a longitudinal axis of rotation between an interface with the user's teeth and a base adjacent the neck N. The base of the polishing cup 70 preferably has a hole 88 disposed therein. The hole 88 is configured to receive the cup adapter 84, coupling the polishing cup 70 to the neck N. Thus, as the second drive shaft 82 rotates, the polishing cup 70 is also made to rotate.

In use, the power source P drives the motor 6, which in turn spins the output shaft 29. This output shaft 29 may then, through the coupling 26, cause the drive shaft 19 to rotate. The drive shaft 19, in turn, may engage the gearbox 80, which comprises a plurality of gears configured to alter the axis of rotation, and preferably the speed of rotation. The gearbox 80 may then cause the second drive shaft 82 to spin, which causes the cup adapter 84 and thereby the polishing cup 70 to spin. Thus, the user may easily polish his or her teeth.

In FIGS. 12A and 12B, an alternative embodiment of the polishing cup 70 is disclosed. As shown, the polishing cup 70 need not comprise a rubber cylindrical element, as shown in the above figures. In one preferred embodiment, for example, the polishing cup 70 may comprise a plurality of bristles 92 affixed to a base 90. The bristles 92 are configured as is well known to those of skill in the art, and may be configured similarly to other circular toothbrush heads that are widely used. The base 90 preferably has disposed therein a hole 88, which may be appropriately sized to receive the cup adapter 84. Thus, the polishing cup 70 shown in FIG. 11 may be replaced by the polishing cup shown in FIGS. 12A and 12B.

In one preferred embodiment, the user may perform the substitution by himself or herself. In another embodiment, the polishing cup 70 may be permanently affixed to the neck N, and different models of the dental device may be configured with different polishing cups. As the term is used herein, polishing cup may be used to describe any of a number of structures that can be used to spread polishing pastes or creams throughout the user's mouth.

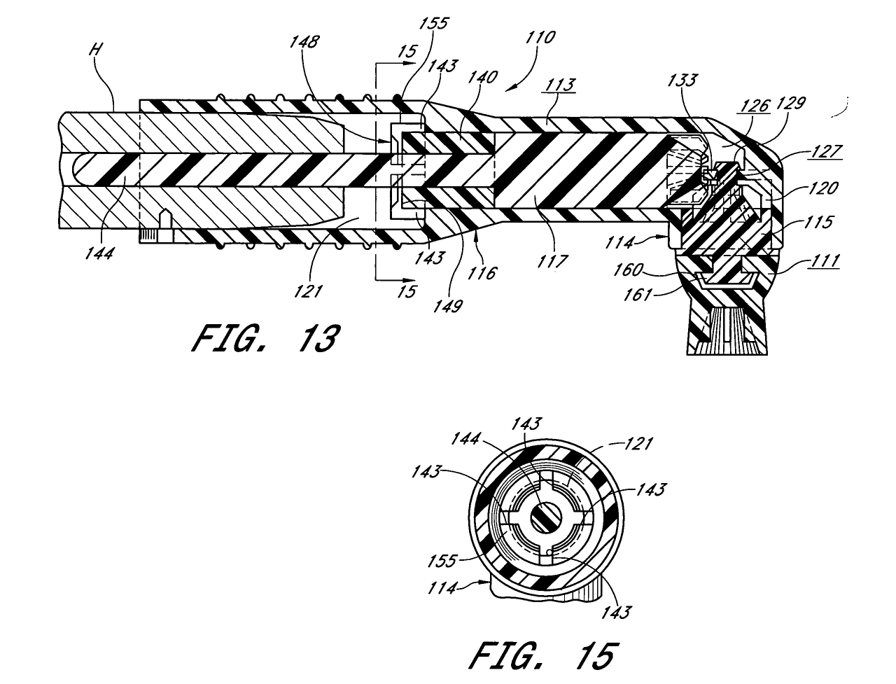

In FIGS. 13-15, one of the necks N that may be used with the dental device shown in FIG. 11 is illustrated in much greater detail. Another commonly used term for such a structure is a “prophy angle,” and, in the following description, this term is used to describe the illustrated structure. Similarly, the polishing cup of the above embodiments is synonymously with the term, “prophy cup,” used below.

Referring first to FIG. 13 of the drawings, a prophy angle, dental prophylaxis right angle 110 is shown. A prophy cup 111 of a conventional type is shown removably positioned on the prophy angle 110. The nose 112 of a powered dental handpiece of conventional type is also shown.

A housing 113 is preferably molded as a single integral unitary unit from plastic. By integral unitary, it is meant that the housing is not an assembly of parts welded together or otherwise interconnected, but a single continuous piece of plastic manufactured as a unitary molded part; The gross housing 113 provides a housing 114 for a prophy cup mounting or rotation member 115 and a housing 116 for an elongated drive shaft 117. The housing 114 has a passageway 120 with a central axis that intersects the central axis of a passageway 121 in the housing 116 at an angle. While the intersecting angle is shown as a right angle and a right angle is preferred in most embodiments, in some embodiments other intersect angles may be preferred.

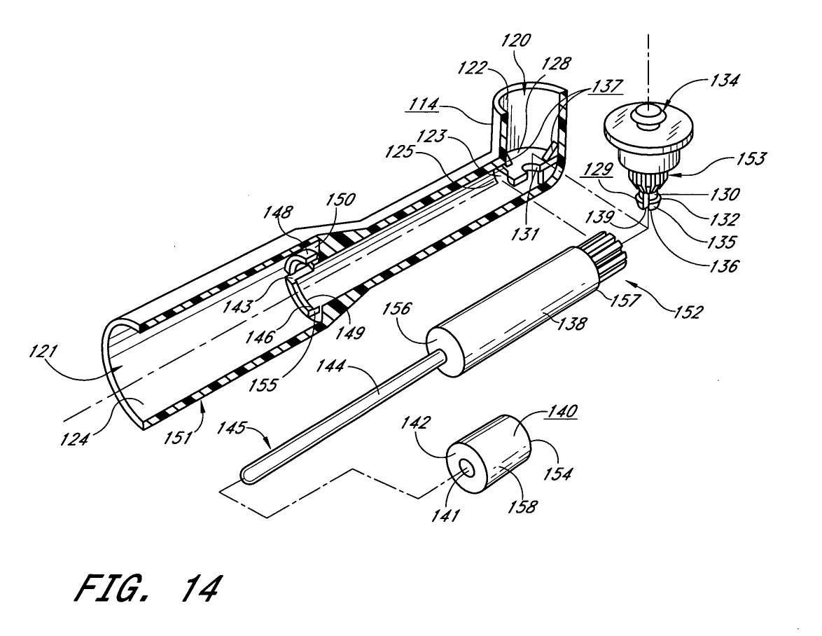

Looking at FIG. 14 it will be understood that housing 114 and its passageway 120 have an outer open end 122 opening out from the gross housing 113 and an inside, inner or inward end with an inner opening 123. The housing 116 and its passageway 121 also has an open end 124 opening out from said gross housing 113 and an inside, inner or inward end with an inner opening 125 which opens into and joins with passage 120. The confluence of passageway 120 and passageway 121 form a mounting and connection section 126 (FIG. 13) of the gross housing 113.

The housing 114, looking at FIGS. 13 and 14, has an attachment retainer 127 that is an integral unitary part of the housing in the form of a strut, shelf 128 (FIG. 14). The prophy cup mounting member or prophylaxis tool mounting member 115 has an end mounting attachment member 129 in the form of a projection or assembly attachment mounting shaft 130 at one end engaged with the attachment retainer 127. In this manner the prophy cup mounting member 115 is attached with and mounted and retained in secured position by the housing 114 in operable position.

Turning now to FIG. 14 it will be seen that the attachment retainer strut 128 is a shelf-like bracket structure that for purposes of expeditious injection molding and function is wholly contained in passageway 120 but is aligned with passageway 121. The shelf 128 extends out from the inside of housing 114, which is part of gross housing 113 in the mounting and connection section 126 of the gross housing 113. The shelf is aligned with the outer opening 124 of the passageway 121 and has a hole or mounting passageway 131 therethrough aligned with the central axis of the second passageway 120. The shelf 128 has a flat retaining surface 133 (FIG. 13) opposite the outer opening 122 of the second passageway and adjacent the hole 131. Webs 137 are strengthening structure.

The prophy cup mounting member projection 130 has a boss or flange 132 at its inner end remote from the prophy cup attachment area or prophylaxis tool mounting portion 134 oriented toward the inside of passageway 120 and sized larger than the hole 131 to be forcibly pushed through the hole 131. The projection 130 preferably has a hollow core at least at its outermost end and has a beveled camming surface 135 therearound to aid in distorting or collapsing the boss inwardly into the hollow core to aid passage of the boss through the hole 131. The hole 131 also has a 15 degree chamber to aid the flange 132 in passing therethrough. There is a slot 139 in the outer end of the hollow core 130 that passes through the wall around the core at two opposed positions to aid the core in bending or distorting inwardly to allow the flange 132 to pass through the hole 131 without damage to the parts.

The flange 132 has at least one mating retaining surface 136 that is not tapered toward the hole 131. Therefore, after the flange 132 is inserted through the hole 131 the prophy cup mounting member 115 is permanently retained against withdrawal, with the retaining surface 133 on the shelf 128 in mating engagement with the retaining surface 136 on the flange 132. The hole 131 and flat surface 133 serve as an attachment bearing, journaling the attachment shaft 130 remote from the driven gear 153. Preferably, the sole means for retaining the prophy cup mounting member 115 within the open end 122 of the housing 114 is the enlarged portion, flange 132 on the attachment shaft 130 engaging with surface 133 on shelf 128.

Turning next to a consideration of the details of mounting the elongated drive shaft 117 in the passageway 121, attention is drawn to both FIGS. 13 and 14. The elongated drive shaft 117 has an enlarged cylinder portion or elongated hub 138, a smaller shaft 144 that is the driving means connection end 145 of the elongated drive shaft 117 and a driving gear portion 152. A locking sleeve 140 fits over the smaller connection shaft 144; preferably, the bore 141 of the sleeve 140 is sufficiently larger than the shaft 144 to prevent frictional engagement during operation with the driving means connection end of smaller shaft 44.

Housing 116 has an interrupted collar retainer portion 148 that mates with a locking face 142 of sleeve 140. The interrupted collar retainer or connector 148 is preferably segmented by slots 143 into a plurality of arms 155 with hook or catch ends 146 having flat faces 149 that snap on to registration with face 142 of sleeve 140 when the cam surfaces 150 are pushed out by the bearing face 154 of the sleeve 140. The control of the resiliency of the snap engagement is provided by the length and thickness of the arms which corresponds to the depth of the slots 143. There are preferably 4 arms and corresponding slots although this can be varied in proper instances and could be desirable from 2 to 6 or even 8 or more in some situations.

The drive shaft 117 has a bearing face 156, which bears against and is frictionally engaged with bearing face 142 of the locking sleeve 140. The only other observed bearing or frictional rotational engagement observed for the drive shaft is in the area 157 where it has been observed the drive shaft leaves a rubbed area on the inside of housing 114 when the parts have been assembled and tested for operation of prototypes. This construction has been found not to develop excess heat during operation.

Turning next to consideration of the provision of the driving connection between the driving gear 152 on the elongated drive shaft 117 and the driven gear 153 of the prophy cup rotating member 115, attention is again directed to both FIGS. 13 and 14. The driving gear 152 is remote from the driving means, dental handpiece, and the connection end of the elongated drive shaft 117. The driven gear 153 is intermediate the end mounting attachment member 130 and the cup attaching area 134 of the prophy cup rotating member 115. The driving gear 152 and the driven gear 153 mesh in the mounting and connection section of the gross housing 113 as shown in FIG. 13 with the driving gear 152 accessing the housing 114 from its side and from the housing 116 through the opening 125. This provides a driving connection between the driving gear 152 and the driven gear 153.

Turning next to the engagement of the prophy cup 111 and prophy cup rotation member 115, attention is again directed to both FIGS. 13 and 14. The device shown for engaging the prophy cup tool on the prophylaxis tool mounting portion 134 of the prophy cup rotation member 115 is a snap over pocket 160 in the resilient “rubber” prophy cup 111 and a stud 161 with an enlarged head. The pocket is sized to match the stud for a tight fit securing the cup tightly against the exposed part of the prophylaxis tool mounting portion 134 in conventional manner. The prophylaxis cup may be of various configurations and a number of configurations are available in the market. The snap arrangement for attaching the prophy cup is also known in other configurations and is not a part of the present invention. It is also known to tap the tool mounting area of the prophylaxis tool mounting member with screw threads for a threaded mounting of the prophy cup in conventional manner. Another preferred embodiment of the prophy cup mounting arrangement involves forming a small cylindrical extention on the stud 161 and a corresponding cylindrical cavity at the bottom of pocket 160 to further stabilize the prophy cup. If the cylindrical cavity is slightly deeper than the portion engaged by the extension on the stud, then even more of the material from which the prophy cup is made may be saved.

Turning next to the cross-sectional view taken at line 15-15 of FIG. 13, the locking sleeve can be seen engaged on the small shaft 144 of the long gear with the arms 155 of the collar locked onto face 142 (FIG. 14). The slots 143 separate the arms 155. The passage 121 within which the shaft 155 is held by the bushing locking sleeve 140 (FIG. 14) is also designated.

Of course, as discussed above, the handle H illustrated above is preferably configured to engage the prophy angle 10. As illustrated in FIG. 13, in one embodiment, some portion of the handle H may insert within the prophy angle 10. However, in alternative embodiments, such as those discussed above, a portion of the prophy angle 10 may be configured to-be inserted within the handle H.

In the course of manufacturing the housing 113, the drive shaft 117, and the driven member 115 may be injection-molded with the housing being formed of polyester (Celanex 2000 product Hoechst Celanese Corp.), and the drive shaft and driven member from Nylon 66-plus mineral filler and short glass fibers (Minlon 22C a product of Dupont). The locking sleeve 140 is preferably constructed of a material suitable as an excellent bearing member such as nylon to aid to low friction rotation. The material used was Nylon (Zytel 101-L a product of Dupont).

It has been found advantageous with a stud height of 0.121 inch and hollow core wall thickness of 0.035 inch in the present construction of the driven member to provide a slot depth of 0.121 inch and a flange thickness in height of 0.068 inch and width of 0.0365 inch. The gear teeth on the short gear are on a hub diameter of 0.2730 with the gears being straight bevel involute 32 DP. There are 7 teeth on each gear. The pitch angle is 20 degrees and the pitch diameter is0.21875 inch. The preferred pitch diameter would be pitch 0.185 to 0.2315 inch. The pitch angle is preferably 10 degrees to 30 degrees, and more preferably 15 degrees to 25 degrees. The arms 155 for locking the locking sleeve in position have been advantageously made 0.163 inch long and 0.163 wide and 0.0190 thick in its thinnest section. The hub at area 157 has a diameter of 0.2235 inch. The long gear has a diameter of 0.2215 inch on the gear hub. The gears on the long gear are identical to those on the short gear with an interference of 0.055 inch between the gears. The preferred gear interference is 0.025-0.1 more preferably 0.040 to 0.07 inch. Good gear mesh is provided by the size of gear teeth and their design or shape. This helps in preventing striping of the gears or disconnection of the gears.

To form the gears it was found that a Gleason gear cutting machine was an expeditious machine for machining the gear teeth in the blank used in making the injection mold for the long and the short gear. The gear teeth have a working depth of 0.055 inch allowing a pull-back of up to 0.020 in the position of the long gear in the housing without materially diminishing working mesh of the gears which would remain 0.035 inch. When the handpiece connects with the right angle it tends to pull or push the long gears position within the housing and this allows good operation.

To mold the housing 113 it may be understood that it is very much preferred to have the attachment retainer housing part 127 in line with both passage 121 and passage 120 to enable the withdrawal of the core pins. It is also preferable to have a small hole in the housing opposite the end mounting member 129 to secure the core pin in position and reduce flash.

After the parts have been molded and cleaned up to remove any flashing and the like the locking sleeve 140 is assembled with the driving shaft 117. The small shaft 144 of the long gear 117 is inserted through the bore 141 of the locking sleeve 140 bringing an end of the locking gear which will thereby become the bearing surface 154 into engagement with the bearing surface 156 on the long gear 117. Then the assembly is snapped into position with the arm 155 of housing 116, engaging the face 141 of the sleeve 140 due to the resiliency of skirts arms 155, which are cammed out by engagement of the camming surfaces 150 engaging with and ride over the outer cylindrical surface 158 of the locking sleeve 140.

The stud that is the shank or projection 115 and boss 130 are inserted into the hole or eyelet 131 with the boss or head 130 being forced through, deforming as it passes through and then extending to permanently mount the driven member 115 within the housing against accidental separation.

Thereafter the driven prophy cup 111 is snapped over stud 161 on the short gear 153, and the mounting member 115 is snapped into position.

Preferred embodiments of the present invention comprise a tooth polishing kit. The kit preferably comprises a dental stain removing device, a plurality of replaceable polishing cups, and dental stain removing cream.

Embodiments of the stain removing device of the present invention may also be used to remove nail polish. Preferred embodiments of the present invention comprise a nail polish removal kit, comprising a stain remover, a plurality of replaceable polishing cups, and nail polish remover.

Although the foregoing description contains many specifics, these should not be construed as limiting the scope of the present invention, but merely as providing illustrations of some of the presently preferred embodiments. Similarly, other embodiments of the invention may be devised that do not depart from the spirit or scope of the present invention. All additions, deletions and modifications to the invention as disclosed herein which fall within the meaning and scope of the claims are to be embraced thereby.

1. A dental device, comprising:
a polishing cup;
a handle having a longitudinal axis generally perpendicular to a longitudinal axis of the polishing cup;
a neck connected to the handle at a proximal end, and connected to the polishing cup at a distal end;
a motor and power source for spinning the polishing cup; and
a shock-absorbing adapter for coupling the neck to the handle.

2. The dental device of claim 1, wherein the neck further comprises a gearbox for reducing a rotational velocity of an output shaft of the motor.

3. The dental device of claim 2, wherein an axis of rotation of the output shaft of the motor is generally perpendicular to an axis of rotation of the polishing cup.

4. The dental device of claim 2, wherein the shock-absorbing adapter surrounds at least a portion of the output shaft.

5. The dental device of claim 1, wherein the power source comprises at least one battery.

6. The dental device of claim 1, wherein the polishing cup comprises a plurality of bristles coupled to a base.

7. The dental device of claim 1, wherein the polishing cup is generally replaceable.

8. The dental device of claim 1, wherein the polishing cup is generally cylindrical and formed from a flexible plastic.

9. A dental stain removing kit, comprising:
a dental device configured as disclosed in claim 1;
a plurality of replaceable polishing cups; and
a stain-removing paste.

10. A dental device, comprising:
a handle, including:
a motor coupled to an output shaft; and
a power source configured to drive the motor;
a neck, including:
a drive shaft coupled to the output shaft;
a second drive shaft;
a gearbox coupled between the drive shaft and the second drive shaft for rotating the second drive shaft slower than and generally perpendicularly to the drive shaft;
a polishing cup coupled to the second drive shaft; and
a shock-absorbing adapter for coupling the handle and the neck.

11. A handle adapted to couple with a dental polishing device comprising a neck having a coupling member, said handle comprising:
a power source;
a motor configured to receive power from the power source, the motor comprising an output shaft; and
an adapter disposed along said output shaft and configured to couple to said coupling member.
